(19) United States
(12) Patent Application Publication
(10) Pub. No.: US 2010/0304124 A1
(43) Pub. Date: Dec. 2, 2010

(54) COATING FORMULATION FOR OFFSET PAPER AND PAPER COATED THEREWITH

(75) Inventors: Jean-Pierre Haenen, Eijsden (NL); Kenneth B. Jewett, Portland, ME (US); Ronald Van De Laar, Zutendaal (BE); Susan E. Snow, Raymond, ME (US)

Correspondence Address: SUGHRUE MION, PLLC, 2100 PENNSYLVANIA AVENUE, N.W., SUITE 800, WASHINGTON, DC, 20037, US

(73) Assignee: SAPPI Netherlands Services B.V., Maastricht (NL)

(21) Appl. No.: 12/739,538

(22) PCT Filed: Oct. 10, 2008
(86) PCT No.: PCT/EP2008/008562

§ 371 Date: Apr. 23, 2010

Related U.S. Application Data
(60) Provisional application No. 60/982,837, filed on Oct. 26, 2007.

(30) Foreign Application Priority Data
Nov. 2, 2007 (EP) 07119853.5

(51) Int. Cl. B32B 5/16; B32B 29/00; B32B 3/26

(52) U.S. Cl. 428/318.4; 428/452; 428/331

(57) ABSTRACT

Coated paper for offset printing comprising at least on one side a top coating layer with improved ink scuff behaviour, said top coating layer comprising a pigment part, the 100 parts in dry weight thereof comprising in the range of 2-40 parts in dry weight of a fine particulate, preferably organosilane surface-treated Phyllosilicate pigment like (as pure as possible) Talcum, a binder part of 2-20 parts in dry weight of binder and optionally additives in the range of 0-8 parts in dry weight.

### TECHNICAL FIELD

The present invention relates to a coated paper for offset printing comprising at least on one side a specific top coating layer to be printed. It furthermore relates to a method for making such a coated paper as well as to specific uses of Talcum pigments for making such papers.

### BACKGROUND OF THE INVENTION

This invention relates to the preparation of paper coating formulations comprising Talcum. By the term “Talcum” (or talc) there is meant a mineral comprising at least 60% by weight and preferably at least 80%, most preferably at least 90% by weight of true mineralogical Talcum, i.e. hydrous (or hydrated) magnesium silicate having the theoretical molecular composition 3MgO.4SiO₂.H₂O or Mg₃[Si₄O₁₀(OH)₂]. The commercially available Talcum mineral, indicated as ‘Talcum’, frequently consists of a mixture of (merely) true lamellar mineralogical Talcum and associated lamellar minerals like Chlorite, also belonging to the Phyllosilicate sub-group of the main group Silicates and having the theoretical molecular composition Mg₅Al₂[Si₃O₁₀(OH)₈] and essentially non-lamellar minerals like Dolomite (calcium magnesium carbonate),

Calcite (calcium carbonate) and Magnesite (magnesium carbonate).

Coated printing papers with low paper gloss, so-called matte papers, have a tendency to “scuff” during required handling after printing in the bindery and/or during shipping (i.e. generally mechanical transport) in comparison to more glossy papers.

The term “scuff” refers to the ink rubbing off from one sheet (donor) to another (receptor) when the paper undergoes a shearing action; alternative terms are “ink scuff” or “ink rub”. The appearance of rubbed off ink on the receptor sheets is objectionable in terms of quality.

Coated matte papers (typically <35% TAPPI 75° paper gloss) with high brightness (typically >94% TAPPI brightness, reflectance at 457 nm) are normally coated with a pigment blend that contains a substantial amount of coarse ground calcium carbonates to keep paper gloss low. In addition, matte papers are not calendered or are only lightly calendered to keep the papers low in gloss and having a rough, textured-feeling surface. The combination of the relative high abrasiveness of the ground calcium carbonate (as compared to other coating pigments) and the large size of the coarse pigment (median particle size, meaning d₅₀, ≧1.5 microns), and the lack of calendering are considered to be the causes of the increase in ink scuff. The lack of calendering can contribute to a tendency to burnish which is the development of gloss streaks when scuffed of rubbed.

Quite often printers will use a clear aqueous overcoat in the last printing station to add a protective surface to the printed paper (so called overprint varnish). The aqueous overcoat allows for the printed paper to go through the bindery and printing without unacceptable scuffing and burnishing. It however adds costs and changes the feel and look of the matte surface.

Previous solutions to the above-mentioned problems include: light calendering, reducing the coarse carbonate levels or adding Talcum. Light calendering and reducing coarse carbonate levels result in higher paper gloss and loss of texture. The addition of Talcum can cause printability issues.

Talcum is a mineral which has many industrial applications: as a relatively cheap and mechanically reinforcing filler or extender for thermoplastics and thermoplastic elastomers, a filler for paint, a thixotropic additive, an anti-clumping and anti-caking additive, a cosmetic base, a raw material in the manufacture of ceramics, as a filler in paper, as a paper coating pigment, as an additive for the control of pitch and resin in paper production (“pitch control”) etc. However Talcum is a low-energetic, hydrophobic, organophilic and inert mineral, unique combined properties which however result in disadvantages in certain existing applications, which can restrict its field of use.

For example, for applications in the ceramics and the paper industry, the hydrophobic nature of Talcum complicates mixing procedures in aqueous media (high energy mixing needed in presence of appropriate system of one or more dispersants and stabilizers) and e.g. weakens its bond to cellulose, which frequently results in the unacceptable occurrence of powdering (the release of Talcum from the surface of the paper).

In applications as filler in polymeric matrices the inert nature of the Talcum prevents it from bonding tightly to the polymer via chemical interactions, which limits certain mechanical reinforcing properties of the filled composite.

Talcum mineral belongs to the vast group of Silicate minerals, more specifically to the subgroup of Phyllosilicates with their common structural property of hexagonal layers of coupled SiO₄-tetraeders. Because of its specific electrically neutral triple-layer crystal structure, the Talcum platelets are only held together by weak v. d. Waals forces, resulting in easy further delamination already under very low shear conditions. This behaviour explains why Talcum with its slippery feeling and lowest value on the Mohs hardness scale adequately can serve as a kind of smearing agent e.g. in case of lowering of ink scuff. Alternative minerals with more or less such smearing agent property can be found within the wide Phyllosilicate group, e.g. Chlorite, Pyrophyllite, some Smectites and hydrous Kaolinite.

Talcum in its natural form thus has a low-energetic, water-repellent or hydrophobic, crystal surface, due to presence of merely Si—O—Si and Si—O groups at the triple-layer surface and only sparely Si—OH groups. This property makes it very difficult to regularly wet Talcum with water and as a result the preparation of an aqueous suspension containing a high proportion by weight of Talcum is expensive in terms of time and energy.

The use of Talcum as a paper coating pigment as such is known (see e.g. US 2004/0067356), it has however always been severely limited because paper coating compositions are conventionally applied in the form of aqueous suspensions of one or more pigments and one or more binders/adhesives. The solids concentration of such a composition is governed by the need for the composition to be sufficiently fluid (rheology) to enable it to be spread evenly over the surface of a paper web by coating machinery and yet to contain the minimum amount of water since the latter must subsequently be removed from the coated paper by thermal evaporation.

The problems caused by the hydrophobic nature of the surface of Talcum have been overcome by introducing e.g. an appropriate system of one or more wetting and/or dispersing agents into the water used for suspending the Talcum.

However, these surface-active agents known at present are expensive and substantially increase the cost of using Talcum as a paper coating pigment. They also have a tendency to produce foam and consequently an antifoaming agent must often be used in conjunction with them, and they may further not only affect the rheology but also the printing properties of the final coating if present in high amounts.

In this context, U.S. Pat. No. 4,430,249 provides a method of treating Talcum in order to make it more readily dispersible in an aqueous medium, which method comprises contacting the Talcum, in a finely divided form, with an aqueous solution of an alkali metal hydroxide or ammonium hydroxide, washing the Talcum after contact with said aqueous solution, and thermally drying the washed Talcum to remove at least a substantial proportion of the water associated therewith.

Furthermore, GB-A-2 211 493 describes a process of treating Talcum with phosphoric compounds such as phosphoric or pyrophosphoric acids. This process produces a deposit of phosphate around the talc particles which gives them apparently hydrophilic properties. This deposit is unstable and easily removed, particularly by washing in bases, ultrasound, etc.

In the case of the substances with an apparently hydrophilic nature described, the hydrophobic nature of the initial Talcum can merely be masked by a peripheral deposit which is not incorporated into the crystalline structure of the Talcum and which can easily be removed. This being the case, it is clear that the hydrophilic property conferred will be very labile.

### SUMMARY OF THE INVENTION

The object of one of the embodiments of the present invention is therefore to provide an improved coating and/or coated paper for offset printing comprising at least on one side a top coating layer. The object of the invention is also to develop a coated e.g. matte paper with preferably high brightness, acceptably low ink scuff, the desired paper gloss, good surface texture, adequate burnish resistance and good printability. The level of ink scuff should be at least the same level as seen for glossy coated papers containing e.g. a high (>50%) calcium carbonate level in the coating. The invention is however not limited to matte papers, as will be seen from the detailed explanations given below.

Said top coating layer comprises (or consists of) the following constituents:
a pigment part, the 100 parts in dry weight thereof comprising in the range of 2-40, preferably of 2-35 parts in dry weight of a fine particulate, organically surface treated and/or impregnated Phyllosilicate pigment,
a binder part of 2-20, typically 4-12 parts in dry weight of binder
(regular) additives in the range of 0-8, typically 0-4 parts in dry weight.

Indeed it was surprisingly found that Talcum, which as such is known to reduce ink scuff when added in a certain amount of typically approximately 20-50 parts in dry weight to the pigment part of a paper coating (with however the above-mentioned severe problems of bringing it into the suspension for the paper coating process), can be used much more efficiently if the Talcum is surface treated and/or impregnated with a dedicated organic molecular system. Specifically, the surface treatment/impregnation is provided for by the use of organic molecules, which typically makes the Phyllosilicate pigment actively even more organophilic.

Though the relative difficulty of suspending such correspondingly modified fine particulate Talcum in water slurry or directly in the coating principally is not changed by the proposed organically surface treated and/or impregnated Phyllosilicate pigment, the surprising finding in this context is that the amount of necessary Talcum to reduce ink scuff can now be reduced dramatically. This not only reduces costs but also reduces the expenses associated with e.g. adapting the rest of the coating formulation when reducing ink scuff problems by the addition of Talcum.

Without being bound to this theoretical explanation it is believed that specific chemical interactions of free organofunctional groups, as present in these organic molecules as used for surface treatment, with the printed ink layer itself contributes to lowered ink scuff behaviour (more intimate contact organically surface treated and/or impregnated, preferably silanized Talcum+ink).

According to a first preferred embodiment, the Phyllosilicate pigment is surface treated and/or impregnated with an organic component, selected from the group consisting of silane coupling agents, polysiloxanes, polyols, fatty acids, fatty acid amines, fatty acid amides, polyether polyols, glycols, fatty acid esters, alkyl sulfonates, aryl sulfonates, in situ calcium stearate in wax and mixtures thereof.

Such systems are as such known in the state-of-the-art, they are however disclosed in the state-of-the-art only in the context of using these surface treated Talcum systems as fillers for plastics, i.e. for thermoplastic systems. Reference is made in this context for example to US-A-2002/0013416, the disclosure of which is expressly included into this specification as concerns systems and methods for surface treating particulate Talcum. It is noted that US-A-2002/0013416 only talks about the use of the Talcum disclosed therein for incorporating it into thermoplastic extrusion material, and the use for other purposes is not disclosed.

It is indeed completely unexpected that the system as disclosed in this document can be applied in the field of paper coating formulations, as paper coating formulations are water-based and therefore hydrophilic. In contrast to this, the Talcum systems as disclosed in US-A-2002/0013416 are normally hydrophobic as they are aimed to be incorporated into a polymer matrix and therefore an organophilic surrounding.

What is furthermore highly unexpected is the fact that these systems can even be incorporated into essentially fully water-based coating formulations at a significantly reduced percentage of the Phyllosilicate in comparison with the rest of the pigment part while however very efficiently reducing ink scuff. This for example allows to reduce or even completely eliminate the use of overprint varnish and/or offset powder and/or specific drying of the printed sheet.

A well-known practical method to invert Talcum from a passive to active, better compatible filler in the filed of polymer matrices is to apply a chemical surface-treatment of Talcum with so-called coupling agents, a selected subgroup of organo-functional silane compounds with general formula

X₃Si(CH₂)ₙ—Y, where
Y stands for halogen, —CN, —NRR′, —COOR etc.;
R, R′=H, CH₃, CH₂CH₃, alkyl etc.;
X=alkyl group, aryl group, halogen, mostly alkoxy group like methoxy group.

The organo-functional silane is impregnated or directly or indirectly chemically bonded via Si—O— bond to the Talcum surface (e.g. via chemical reaction of its sparely present surface hydroxyl groups with e.g. the methoxy or ethoxy groups of the silane compound, under formation of e.g. methanol/ethanol) and the free functional group (e.g. the primary alkylamine) at the silane is available for essential chemical interaction with the polymer matrix. These are the systems also envisaged in the present context.

Two examples of such coupling agents: 3-aminopropyl(tri-ethoxy)silan H₂NCH₂CH₂CH₂Si(OC₂H₅) and 3-(2-aminoethylamine)propyl(trimethoxy)silan H₂NCH₂CH₂NHCH₂CH₂CH₂Si(OCH₃).

Prior art does include using Talcum for ink scuff resistance, it however does not include using a organically surface treated and/or impregnated Talcum, let alone a silanized Talcum, and does not try to develop soft pigment formula for e.g. a matte product. Work concentrates on how to make coarse ground carbonate systems work. Starch pigments have been used to improve ink rub for matte grades but experience is that they have poor optical and print properties. High coarse clay formulas have been used but they are of lower brightness. Amorphous silica is used in coatings for ink jet applications, it was developed for use by the applicant for offset coated printing papers to accelerated ink drying, it is however not known to be used for burnish resistance in offset coated matte printing papers.

There is no mention of using organically surface treated and/or impregnated, let alone e.g. silanized Talcum in previous work in paper coatings. Such systems are only used e.g. as anti-block agent in the production of polyolefin films. In these applications according to the state-of-the-art the silane treatment helps to prevent the Talcum from absorbing processing aids that interfere with the production of the film. Pigments used in the plastics industry are not normally thought of as potential pigments for aqueous paper coatings.

The use of the organically surface treated and/or impregnated and e.g. silanized Talcum as an ink scuff aid was discovered while performing screening bench work looking for a pigment alternative to fine clay and calcium carbonate. An untreated Talcum had been used previously in the development work with only minimal ink rub improvement. A specifically preferred system is given, if the Phyllosilicate pigment is surface-treated and/or impregnated with an organosilane and/or organosilanol component. For the specifics of such a system again reference is made to the disclosure of US-A-2002/0013416 which is included into the specification as concerns the organosilane and/or organosilanol component as well as the preparation of the Talcum pigment treated with these systems.

The organically surface treated and/or impregnated, preferably silanized Talcum gives good ink rub, low paper gloss and increased burnish resistance with minimal impact on brightness. The silica is neutral or negative with respect to ink rub but improves ink set time, lowers paper gloss and increases burnish resistance. An additional precipitated calcium carbonate (PCC)-pigment present in the pigment part improves optics and back trap mottle by helping to structure the coating. An additional aluminium tri-hydroxide-pigment (ATH) present in the pigment part gives brightness with a minimal negative impact on ink rub. One important aspect is balancing all the properties.

The organically surface treated and/or impregnated, preferably silanized Talcum is one important aspect to the invention as it provides the improved ink rub while still obtaining the low paper gloss required for a matte product. The amorphous silica if also present in the pigment part of the coating formulation allows a better balance of properties to be obtained, especially for a high brightness matte grade where other options are likely to impair brightness. The aluminium tri-hydroxide pigment present in the pigment part of the coating formulation is mostly to offset the lower brightness of the Talcum and would not be critical for lower brightness grades. The PCC if present in the coating formulation is a way to add structure and brightness to the coating. There are potential possible other materials that can provide the function of PCC but not with this combination of cost and brightness.

The pigment sizes can sometimes be critical to obtain a reasonable balance between ink rub, paper gloss and burnish resistance. The organically surface treated and/or impregnated (preferably silanized) Talcum should preferably have a median particle size between 2 and 8 μm. The aluminium tri-hydroxide particle size should preferably be less than 0.8 μm. The silica particle size should preferably be 3 to 6

A plastic pigment can be added to the formula at 5 to 15 parts in dry weight of the pigment part to change the balance of properties and e.g. to improve gloss.

PCC can be substituted for aluminium tri-hydroxide to lower costs (10 to 30 parts) for a lower brightness matte product. Also coarse clay can be substituted for some of the organically surface treated and/or impregnated (e.g. silanized) Talcum (10 to 30 parts).

When a moderate improvement in ink rub is needed and minimal changes in the pigment package are desired the best approach plan, according to another embodiment of the invention, can be to add 5 to 15 parts of the largest size organically surface treated and/or impregnated (e.g. silanized) Talcum that is acceptable for the desired paper and ink gloss.

Possible systems as available on the market in this respect are the products Mistrobond, most preferably Mistrobond C and Mistrobond R10C, as available from Talc de Luzenac (FR), another possibility is the product available under the name Polybloc from Speciality Minerals Inc. (US). Both systems are up to now only known e.g. as fillers for polyolefin systems and polyolefin film applications. Correspondingly therefore, preferably the Phyllosilicate (Talcum) pigment is essentially coated by an organosilane, wherein most preferably the organosilane is selected from the group consisting of: aminoalkyl-organosilane, vinyl-organosilane, secondaryaminoalkyl-organosilane, sulfanealkyl-organosilane, mercaptoalkyl-organosilane, methacrylatealkyl-organosilane, polyetheralkyl-organosilane, epoxyalkyl-organosilane.

As already mentioned above, according to a preferred embodiment, the Phyllosilicate pigment is a Talcum pigment. Typically the Phyllosilicate pigment has a hardness below 2 on the Mohs scale, preferably in the range of 1.

According to a further preferred embodiment, the Phyllosilicate pigment, preferably selected to be Talcum, has a median particle size in the range of 1-8 μm, preferably in the range of 2-4 μm.

According to a further embodiment of the invention, the organically surface treated and/or impregnated Phyllosilicate pigment, typically silanized Talcum pigment, is present in the pigment part in 3-35, preferably 4-25 parts in dry weight, most preferably 4-15 parts in dry weight.

Indeed one can show that depending on the desired paper gloss, different optimum compositions of the paper coating when combined with the proposed organically surface treated and/or impregnated Phyllosilicate pigment can be found.

According to a preferred embodiment for a matte paper, i.e. of a paper with a gloss of less than 50% TAPPI 75°, preferably of less than 40% TAPPI 75°, most preferably of less than 35% TAPPI 75°, the organically surface treated and/or impregnated Phyllosilicate pigment is present in the pigment part in an amount of 2-40 parts, preferably of 3-35 parts. With the proposed silanized Talcum, however also lower contents are possible in the range of 4-15 parts. The gloss may even go down to values of below 10% or even below 5% TAPPI 75°, and the invention also pertains to papers of this gloss grade.

Typically in the case of matte papers, the 100 parts in dry weight of the pigment part consist of:

2-40, preferably 3-35, most preferably 5-25 parts in dry weight of a fine particulate, organically surface treated and/or impregnated Phyllosilicate pigment, preferably of a silanized Talcum,

1-20, preferably 3-12 parts in dry weight of a fine particulate amorphous silica and/or precipitated silica, preferably amorphous silica gel, most preferably with a median particle size in the range of 1-6 μm, preferably of 2-6 μm,

and the remainder supplementing to 100 parts in dry weight of the pigment part of a fine particulate pigment selected from the group of: calcium carbonate, kaoline, titanium oxide, clay, plastic pigment, aluminium trihydroxide, gypsum, barium sulphate (and eventually other pigments as common in the field of paper coating pigments). Preferably this remainder of the pigment part (apart from the above silanized Talcum and silica) comprises 10-40 parts in dry weight of precipitated calcium carbonate and/or 5-15 parts in dry weight of a plastic pigment, and/or 10-50 parts in dry weight of aluminium tri-hydroxide. In case of use of aluminium tri-hydroxide, the median particle size of the aluminium tri-hydroxide preferably is less than 1.5 μm, more preferably less than 1.0 μm, most preferably less than 0.8 μm.

In case of use of a plastic pigment, generally in this document, this is preferably a hollow or solid particulate polymer pigment selected from the group consisting of: poly(methyl methacrylate), poly(2-chloroethyl methacrylate), poly(isopropyl methacrylate), poly(phenyl methacrylate), polyacrylonitrile, polymethacrylonitrile, polycarbonates, polyetheretherketones, polyamides, acetals, polyphenylene sulfides, phenolic resins, melamine resins, urea resins, epoxy resins, (modified) polystyrene latexes, polyacrylamides, based on styrene maleic acid copolymeric latexes (SMA) and/or styrene malimide copolymeric latexes (SMI), and alloys, blends, mixtures and derivatives thereof.

Typically a matte paper according to the present invention is uncalendered or only lightly calendered.

In case of matte papers, it can be advantageous to make sure that the coating formulation is essentially free of coarse pigments, particularly of coarse calcium carbonate pigments, most preferably of coarse ground calcium carbonate pigments. When talking about coarse pigments in this respect this means having a median particle size of larger than or equal to 1.5 μm.

For medium gloss papers slightly different compositions of the top coating formulation, specifically of the pigment part thereof, were found. Correspondingly therefore according to a further embodiment of the invention, for a medium gloss paper, i.e. for a paper with a gloss of in the range of 30-75% TAPPI 75°, preferably of 40-60% TAPPI 75°, the organically surface treated and/or impregnated Phyllosilicate pigment is present in the pigment part in an amount of 2-30 parts, preferably of 4-20 parts.

In the situation of a medium gloss paper, according to an embodiment, the 100 parts in dry weight of the pigment part consist of:

2-30, preferably 3-20 parts in dry weight of a fine particulate, organically surface treated and/or impregnated Phyllosilicate pigment, preferably of a silanized Talcum,

0-20, preferably 3-12 parts in dry weight of a fine particulate amorphous silica and/or precipitated silica, preferably amorphous silica gel, most preferably with a median particle size in the range of 1-6 μm, preferably of 2-6 μm,

and the remainder supplementing to 100 parts in dry weight of a fine particulate pigment selected from the group of: calcium carbonate, kaoline, titanium oxide, clay, plastic pigment, aluminium trihydroxide, gypsum, barium sulphate (and eventually other pigments as common in the field of paper coating pigments), wherein preferably this remainder comprises 10-40 parts in dry weight of precipitated calcium carbonate and/or 5-15 parts in dry weight of a plastic pigment, and/or 10-30 parts of clay and/or 20-40 parts in dry weight of aluminium tri-hydroxide.

In this case the median particle size of the aluminium tri-hydroxide is preferably lower than the one as given above matte papers, specifically, preferably the median particle size of the aluminium tri-hydroxide is less than 1.5 μm, more preferably in the range of 0.5-0.8 μm.

Considering now high gloss papers, i.e. papers with typically a gloss of above or equal to 60% TAPPI 75°, preferably above 75% TAPPI 75°, most preferably above 80% TAPPI 75°, one notes that the organically surface treated and/or impregnated Phyllosilicate pigment is preferably present in the pigment part in an amount of 2-20 parts, preferably of 4-10 parts.

According to another embodiment of the invention, in case of a high gloss paper, the 100 parts in dry weight of the pigment part thus consist of:

2-20, preferably 3-10 parts in dry weight of a fine particulate, organically surface treated and/or impregnated Phyllosilicate pigment, preferably of a silanized Talcum,

0-20 in dry weight of a fine particulate amorphous silica and/or precipitated silica, preferably amorphous silica gel, most preferably with a median particle size in the range of 1-6 μm, preferably of 2-6 μm (preferably the precoat contains 3-12 parts of such a silica in this case),

and the remainder supplementing to 100 parts in dry weight of a fine particulate pigment selected from the group of: calcium carbonate, kaoline, titanium oxide, clay, plastic pigment, aluminium trihydroxide, gypsum, barium sulphate (and eventually other pigments as common in the field of paper coating pigments), wherein preferably this remainder comprises 0-50 parts, preferably 5-50, in dry weight of precipitated calcium carbonate and/or 5-15 parts in dry weight of a plastic pigment and/or 0-40 parts of a fine (meaning a median particle size below 1.5 μm, preferably below 1 μm, most preferably below 0.8 μm) ground calcium carbonate and/or 5-40 parts in dry weight of aluminium tri-hydroxide. In this case, typically the median particle size of the aluminium tri-hydroxide is even lower than the one as given in the two cases discussed above, namely preferably the median particle size of the aluminium tri-hydroxide preferably is less than 1.0 μm, more preferably in the range of 0.2-0.5 μm.

The proposed use of Talcum in the coating formulation for offset printing purposes is most useful in the case where ink scuff can be a problem, which for example is the case if the pigment comprises other constituents prone to generating such ink scuff problems.

According to another embodiment of the invention therefore, the pigment part generally further comprises (apart from the fine particulate, organically surface treated and/or impregnated Phyllosilicate pigment in the specific amount chosen), preferably consists of, 60-98 parts in dry weight of a fine particulate pigment selected from the group: carbonate, kaoline, plastic pigment, clay, titanium oxide, aluminium trihydroxide, gypsum, barium sulphate, silica, preferably amorphous silica gel.

Or put in other words, these constituents form the rest of the pigment part complementing the organically surface treated and/or impregnated Phyllosilicate pigment to 100% (dry weight).

Preferably, the 100 parts in dry weight of the pigment part comprise, preferably consist of:

2-30, preferably 3-15 parts in dry weight of a fine particulate, organically surface treated and/or impregnated Phyllosilicate pigment, preferably of a silanized Talcum pigment,

1-20, preferably 8-12 parts in dry weight of a fine particulate silica and/or precipitated silica, preferably amorphous silica gel,

and 50-97 parts in dry weight of a fine particulate pigment selected from the group of: calcium carbonate, titanium oxide, kaoline, clay, plastic pigment, aluminium trihydroxide, gypsum, barium sulphate (and eventually other pigments as common in the field of paper coating pigments).

Correspondingly therefore, the specific Talcum pigment is present in the pigment part in the range of 2-15 parts in dry weight, preferably 3-8 parts in dry weight, most preferably in the range of 4-7 parts in dry weight, additional 1-20, preferably 8-12 parts in dry weight are given by a fine particulate silica and/or precipitated silica, preferably amorphous silica gel, and the rest of the pigment part supplementing to 100% is given by further pigments like the above defined group of pigments (carbonate, kaolin, clay, plastic pigment, gypsum, barium sulphate, or other pigments known in the field of coatings of offset printing papers also possible, and mixtures thereof).

Specifically in the context of the presence of a fine particulate silica, especially in the presence of an amorphous silica gel, providing small particles of high hardness in the coating, where ink scuff can be a problem, the proposed Talcum system is very efficient and develops a high ink scuff reduction effect even at low percentages, i.e. if present in for example 3-8 parts in dry weight in the total of the pigment part.

Typically, such a fine particulate silica has an internal pore volume above 0.2 ml/g, preferably above 0.5 ml/g, even more preferably above 1.0 ml/g and/or the fine particulate silica has a surface area (BET) above 100, preferably above 250, even more preferably of at least 300 m²/g, wherein preferably the surface area is in the range of 200-1000, preferably in the range of 200-800 m²/g.

As already mentioned above, for many offset paper coating applications it is beneficial if the Phyllosilicate pigment is a Talcum pigment and is present in the pigment part in the range of 3-8 parts in dry weight, preferably in the range of 4-7 parts in dry weight, the rest of the pigment part being constituted by other pigments as known in the field, specifically by the pigments as already discussed above.

Generally the proposed coating formulation can be applied to low, medium or high brightness coating applications. Correspondingly therefore, the coated final paper may have a TAPPI brightness value in the range of 80-90% (low brightness), in the range of 90-94% (medium brightness) or in the range of above 94% (high brightness).

For certain applications it can be advantageous if also the precoat, i.e. the coating immediately beneath and in contact with the top coating, has a specific coating formulation. For example in view of ink setting properties, it may be advantageous if the precoat comprises silica, preferably amorphous silica, most preferably silica gel pigment. Such a precoat coating formulation may consist of a pigment part, wherein this pigment part is composed of 75-98 parts in dry weight of a mixture of or a single fine particulate pigment, preferably a calcium carbonate pigment, 2-25 parts in dry weight of a fine particulate silica, and a binder part. The fine particulate silica pigment can have the characteristics as outlined in the context of the top coating.

As discussed above, the paper can preferably be printed in an offset printing process without the use of offset powder and/or without irradiative drying after printing and/or without use of overprint varnish.

The present invention furthermore relates to the use of a fine particulate surface treated/impregnated Phyllosilicate pigment as defined above, preferably of a correspondingly treated Talcum pigment, most preferably of an organosilane treated and/or impregnated Talcum pigment, in a paper coating formulation for reducing and/or eliminating ink scuff in offset printing processes. It furthermore relates to a process for making a paper coating formulation comprising such a Phyllosilicate pigment in an amount leading to a final dry weight contribution as given above.

Further embodiments of the present invention are outlined in the dependent claims.

### SHORT DESCRIPTION OF THE FIGURES

In the accompanying drawings preferred embodiments of the invention are shown in which:

FIG. 1 a schematic cut through a coated printing sheet;

FIG. 2 a graphic comparison of ink scuff of papers of the second laboratory trial series.

### DETAILED DESCRIPTION OF THE PREFERRED EMBODIMENTS

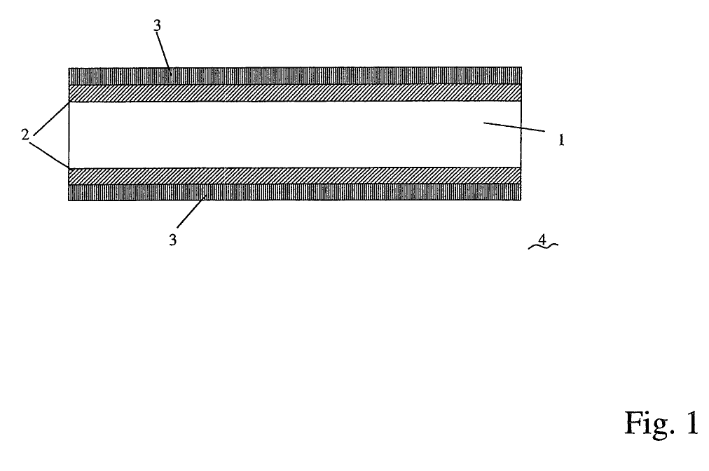

Referring to the drawings, which are for the purpose of illustrating the present preferred embodiments of the invention and not for the purpose of limiting the same, FIG. 1 shows a schematic view of a coated printing sheet. The coated printing sheet 4 is coated on both sides with layers, wherein these layers constitute the image receptive coating. In this particular case, a top coating 3 is provided which forms the outermost coating of the coated printing sheet. Beneath this top layer 3 there is provided a second layer 2. In some cases, beneath this second layer there is an additional third layer (not shown), which may be a proper coating but which may also be a sizing layer.

Typically a coated printing sheet of this kind has a base weight in the range of 80-400 g/m², preferably in the range of 100-250 g/m². The top layer e.g. has a total dried coat weight of in the range of 3 to 25 g/m², preferably in the range of 4 to 15 g/m², and most preferably of about 6 to 12 g/m². The second layer may have a total dried coat weight in the same range or less. An image receptive coating may be provided on one side only, or, as displayed in FIG. 1, on both sides.

The main target of this document is to provide a coated printing sheet for low ink-scuff, preferably quick ink drying applications for sheet-fed or roll-offset papers in combination with standard inks. Pilot coated papers and mill trial papers were printed on a commercial sheet-fed press and ink scuff tests were carried out. The invention is also the development of matte (but also medium gloss and high gloss) coating formulation that provides high brightness, good ink rub resistance, low paper gloss (in case of matte papers), good burnish resistance, good ink set time, good ink film continuity and printed without defects such as Back Trap Mottle, Mid-Tone Mottle (screen mottle), or picking, which can preferably be printed without (or reduced) the use of offset powder or overprint varnish. Preferred embodiments use a combination non-traditional soft and fine pigments in combination with more traditional paper pigments to get greatly improved ink rub performance for a matte coated paper.

Wet Ink Rub Test (Ink Scuff Test):

The term “scuff” refers to the ink rubbing off from one sheet (donor) to another (receptor) when the paper undergoes a shearing action, as outlined above; alternative terms are “ink scuff” or “ink rub”. The appearance of rubbed off ink on the receptor sheets is objectionable in terms of quality. Correspondingly, one understands such ink markings by ink scuff. Such ink markings can be produced by different causes which can be quantified using different tests: * if the ink is not fully dry→seen in wet ink rub test; * if the ink is fully dry→seen in ink rub resistance test. The wet ink rub test, which is a convertibility test, is detailed here. The ink rub resistance test shares the same principle as the wet ink rub test, but it is carried out after the ink has dried for 48 hours.

Scope: The method describes the evaluation of the rub resistance of papers and boards at several time intervals after printing, before full drying. Normative References/Relating International Standards: GTM 1001: Sampling; GTM 1002: Standard Atmosphere for Conditioning; ESTM 2300: Prüfbau printing device-description and procedure. Relating Test methods descriptions: Prüfbau manual.

### DEFINITIONS

Ink-rub: when submitted to mechanical stress like shear or abrasion, ink layers can be damaged and cause markings on the printed products, even if they are fully dried.
Chemical drying: in sheet fed offset, the hardening of the ink film via reactions of polymerisation.
Wet ink rub value: measurement of the amount of ink that has marked the counter paper during the wet ink rub test at a given time after printing.

Principle: A test piece is printed with commercial ink at the Prüfbau printing device. After several time intervals, a part of the printed test piece is rubbed 5 times against a blank paper (same paper). The damaging of the print and the markings on the blank paper are evaluated and plotted against a time scale. Printing ink Tempo Max black (SICPA, CH) is used.

Laboratory procedure: 1. Adjust the printing pressure to 800N, 2. Weigh the ink with a tolerance of 0.01 g and apply the amount of ink on the inking part of the Prüfbau printing device, 3. Distribute the ink for 30 s, (the ink distribution time can be lengthened to 60 s for easier manipulation), 4. Fix the test piece on the short sample carrier, 5. Place the aluminium Prüfbau reel on the inking part and take off ink for 30 s, 6. Weigh the inked reel (m₁), 7. Put the inked aluminium Prüfbau reel on a print unit, 8. Put the sample plate against the inked aluminium reel, print the test piece at 0.5 m/s, 9. Mark the time at which the sample as been printed, 10. After printing, weigh again the inked reel (m₂) and determine the ink transfer Iₜ in g (Note: the ink transfer Iₜ is given by Iₜ=m₁−m₂ where m₁ is the weight of the inked reel before printing and m₂ the weight of the same reel after printing), 11. Adjust the number of rubbing on the Prüfbau ink rub resistance tester to 5, 12. Cut a round piece in the printed strip with the Prüfbau piece cutter. 13. Stick the test piece against one of the Prüfbau test piece carrier, and fix a blank strip of the same paper on the paper carrier, 14. After a defined time interval after printing, place the blank paper and the printed round piece face to face on the Prüfbau device and start the rubbing (five times), 15. Recommence the operation for all defined time intervals after printing and then, evaluate the papers drying as a function of the density of markings on the blank paper/damaging of the printed paper.

The chart below provides an example for the amount of ink to be weighed for the printing and the times after printing at which the ink rub test can be performed:

| Grades | Ink amount | Rubbing times (min.) |
|---|---|---|
| Gloss | 0.30 g | 15/30/60/120/480 |
| Silk/Matt | 0.30 g | 30/60/240/360/480 |

Results evaluation: The results are both measured and evaluated visually. Visual evaluation: order all the tested blank samples from best to worse as a function of the amount of ink that has marked the blank paper. Measurement: with the Colour Touch device, measure the colour spectrum of the blank samples (light source UV excluded). Measure the colour spectrum of the untested white paper. The colour spectra of the tested samples have a peak of absorption at a defined wavelength, which is typical for the ink used (this is the colour of the ink). The difference of the reflectance factors at this wavelength between the tested sample and the white untested sample is an indication of the ink rub. With the SICPA Tempo Max Black, the peak wavelength is 575 nm and InkRub=(Rₛₐₘₚₗₑ−R_{blank})_{575 nm}.

Laboratory Experiments, First Part:

Table 1 show the different test papers which were used for the subsequent analysis. Eight different papers were made using a laboratory coater (Bird applicator) for the application of top coatings with the formulations as given in the Table 1. The coating formulation was adjusted to a solids content of 62%. The coatings were applied to a standard pre-coated wood free paper, having a middle coat layer identical to the ones as they are specifically described in the mill trial experiments outlined in more detail in the corresponding section below (Table 3).

TABLE 1
Formulations and results of first laboratory trial papers.

| | Expt. No. | | | | | | | |
|---|---|---|---|---|---|---|---|---|
| | 1 | 2 | 3 | 4 | 5 | 6 | 7 | 8 |
| | 1 | 2 | 3 | 4 | 5 | 6 | 7 | 8 |
| PIGMENT | | | | | | | | |
| HC 90 GU | 75 | 65 | 68 | 71 | 73 | 51 | 71 | 68 |
| SC HG GU | | | | | | 20 | | |
| Miragloss 90 | 15 | 15 | 15 | 15 | 15 | 15 | 15 | 15 |
| Syloid C803 | 10 | 10 | 10 | 10 | 10 | 10 | 10 | 10 |
| Standard Talcum | 0 | 10 | 7 | 4 | 2 | 4 | | |
| Mistrobond C | | | | | | | 4 | 7 |
| BINDER | | | | | | | | |
| Acronal | 9 | 9 | 9 | 9 | 9 | 9 | 9 | 9 |
| Basonal | 2 | 2 | 2 | 2 | 2 | 2 | 2 | 2 |
| Additives | 1.3 | 1.3 | 1.3 | 1.3 | 1.3 | 1.3 | 1.3 | 1.3 |
| Water | 121.8 | 110.3 | 117.1 | 120.6 | 122.9 | 118 | 131.3 | 135.9 |
| INK RUB LAB TS 1 | 2.71 | 2.53 | 3.01 | 2.86 | 2.94 | 3.06 | 2.41 | 2.17 |
| INK RUB LAB TS 2 | 6.22 | 5.54 | 5.85 | 5.85 | 6.16 | 7.81 | 2.82 | 2.67 |

Constituents:
HC 90 GU: Ground calcium carbonate pigment “HYDROCARB HC 90 GU”, as available from OMYA, CH, has a median particle diameter in the range of 0.7-0.8 micrometer, and a particle size distribution such that approximately 90% of the particles are smaller than 2 micrometer and approximately 66% of the particles are smaller than 1 micrometer.
SC HG GU: Ground calcium carbonate pigment “SETACARB HG GU”, as available from OMYA, CH, has a median particle diameter in the range of 0.4-0.6 micrometer, and a particle size distribution such that approximately 98% of the particles are smaller than 2 micrometer and approximately 90% of the particles are smaller than 1 micrometer.
Miragloss 90: Fine particle kaolin pigment, as available from BASF, DE, with a Sedigraph particle size of approximately 92%<1 micrometer.
Syloid C803: Amorphous silica gel as available from Grace Davidson, DE, with a total pore volume of 2.0 ml/g, an average particle size of 3.7 micrometer, a surface area (BET) in the range of 300-330 m²/g and an anionic surface charge.
Standard Talcum: A standard Talcum as available on the market under the trade name Finntalc C10 from Mondo minerals OY, FL was taken, with a particle size distribution such that approximately 96% of the particles are smaller than 10 micrometer, approximately 82% of the particles are smaller than 5 micrometer and approximately 46% of the particles are smaller than 2 micrometer.
Mistrobond: Surface treated microcrystalline Talcum as available under the trade name Mistrobond C or almost equivalent Mistrobond R10C from Talc de Luzenac (Rio Tinto group), FR, with a mean particle size of 2.9 micrometer and a particle size distribution such that approximately 95% of the particles are smaller than 11 micrometre, with a surface area (BET) of 11 m²/g. It comprises more than 98% pure Talcum (rest e.g. about 0.5% Chlorite and 1% Dolomite) and has a hardness of 1 Mohs. The surface treatment comprises an organo-functional silane component (so-called coupling agent) comprising a primary amino-alkyl functional group.
Acronal: Binder as aqueous dispersion of a copolymer on the basis of styrene and acrylic esters, as available from BASF, DE.
Basonal Binder according multi-monomer concept based on the monomers acrylonitrile, butadiene, butyl acrylate and styrene, as available from BASF, DE.
Additives: Several additives are added as needed, in the specific case polyvinylalcohol (PVAL), dispersion aids, brighteners, thickeners, antifoaming products etc. as well known to the person skilled in the art.

Two different dry ink rub measurements were carried out, the first one designated as INK RUB LAB TS 1 indicates a measurement on the top side after having printed the sheet with the commercial ink black Tempo Max as available from SICPA, FR, and a second one designated as INK RUB LAB TS 2 indicates a similar measurement on the top side after having printed the sheet with commercial ink Cyan Öko plus 230 ink as available from Epple, DE. The latter ink is known to be much more prone to ink scuff problems.

As one can see from the results as summarised in Table 1, indeed the surface treated Talcum Mistrobond, even if added in relatively small amounts of 4 or 7 parts in dry weight of the pigment part (see experiment 7 and 8) is able to impressively reduce the ink rub value even for the more demanding second ink system. The use of standard Talcum, even at high amounts, does not allow effectively reaching ink scuff values as low as possible with the newly proposed system.

Laboratory Experiments, Second Part:

Table 2 shows further test papers which were used for verification of the new ink scuff reducing concept. Three different papers were made using a laboratory coater (Bird applicator) for the application of top coatings with the formulations as given in the Table 2. The coating formulation was adjusted to a solids content of 64% and a pH of 8.4. The coatings were applied to a standard pre-coated wood free paper, having a middle coat layer identical to the ones as they are specifically described in the mill trial experiments outlined in more detail in the corresponding section below (Table 3).

TABLE 2
Formulations and results of second laboratory trial papers.

| Expt. No. | 7 | 11 | 12 |
|---|---|---|---|
| PIGMENT | | | |
| HC 95 ME | 75 | 75 | 75 |
| HC V40 ME | 10 | 15 | |
| Hydragloss 90 | 5 | | 10 |
| Syloid 72 | 10 | 10 | 10 |
| Mistrobond C | | | 5 |
| BINDER | | | |
| Acronal | 10 | 10 | 10 |
| Litex | 1 | 1 | 1 |
| ADDITIVES | 1.6 | 1.6 | 1.6 |
| Water | 130 | 136.4 | 138.5 |
| Ink rub Lab | 2.28 | 2.21 | 1.94 |

Constituents:
HC 95 ME: Ground calcium carbonate pigment “HYDROCARB HC 95 ME”, as available from OMYA, CH, has a median particle diameter in the range of 0.5-0.6 micrometer, and a particle size distribution such that approximately 95% of the particles are smaller than 2 micrometer and approximately 78% of the particles are smaller than 1 micrometer.
HC V40 ME: Speciality co-structured calcium carbonate/Talcum pigment slurry Hydrocarb VP-ME V40 T 60%, as available from OMYA, CH, and as broadly described in WO 99/52984, it has a mean particle diameter in the range of 0.7-0.8 micrometer, and the particle size distribution is such that approximately 84% of the particles are smaller than 2 micrometer and approximately 62% of the particles are smaller than 1 micrometer.
Hydragloss 90: Fine particulate kaolin pigment, as available from OMYA, CH, with a Sedigraph particle size of approximately 97%<1 micrometer.
Syloid 72: Amorphous silica gel as available from Grace Davidson, DE, with a total pore volume of 1.1 ml/g, an average particle size of 5.0 micrometer, a surface area (BET) in the range of 345-370 m²/g and an anionic surface charge.
Binder as aqueous dispersion of a carboxylated styrene-butadiene copolymer, as available e.g. from Polymer Latex GmbH, DE.
Additives: Several regular additives are added as mentioned previously at Table 1.

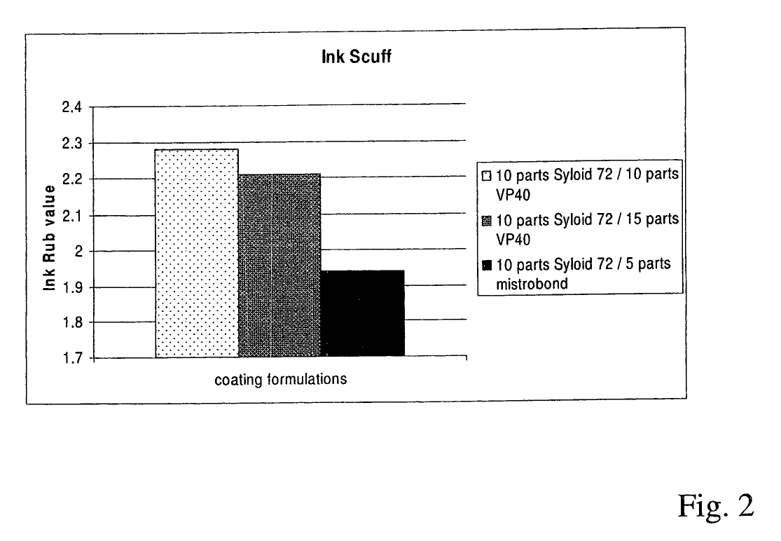

Also here the dry ink rub was measured for the first type of ink (black Tempo Max, Sicpa Fr). The results are graphically indicated in FIG. 2, and one can clearly see that no constituent of the pigment part is able to as efficiently reduce ink scuff as the proposed surface-treated Talcum. Indeed using the proposed coating formulation it was possible to essentially reduce (reduction to half of the usual amount) or even fully eliminate the use of offset powder/overprint varnish without any unacceptable ink scuff problems. The rest of the properties of the paper is not measurably altered by the addition of the proposed surface-treated Talcum, making it an ideal supplement in case of ink scuff problems, as its addition does not necessitate further amendments of the rest of the coating formulation due to secondary effects introduced by the special Talcum.

Mill Trial Experiments:

Table 3 shows test papers which were made in the mill on a paper coating machine, for verification purposes. Two different papers were made with the formulations as given in the Table 3. The coating formulation was adjusted to a solids content of 64% and a pH of 8.4.

TABLE 3
Formulations and results of two mill trial papers (Pre:
pre-coat layer formulation, below middle layer; Mid:
Middle layer formulation; Top: top layer formulation).

| | | Mill trial 3 | | 115 g/135 g | Mill trial 10 | | 115 g |
|---|---|---|---|---|---|---|---|
| | % | Pre | Mid | Top | sizing | Mid | Top |
| PIGMENT | | | | | | | |
| HC 60 BG | 76 | 100 | 25 | | | 25 | |
| Mistrobond | 99 | | | | | | 5 |
| HC 90 GU | 76.5 | | 35 | 75 | | 35 | 40 |
| Setacarb HG | 75 | | 40 | | | 40 | 30 |
| Miragloss | 70 | | | 15 | | | 15 |
| Syloid C803 | 99 | | | 10 | | | |
| Syloid 72 | 99 | | | | | | 10 |
| BINDER | | | | | | | |
| Basonal | 50 | 7 | 10 | 2 | | 9 | 1 |
| Acronal | 50 | | | 9 | | | 8.5 |
| Additives | | 13 | 0.6 | 1.3 | | 0.6 | 1 |
| dry solids % | | 60 | 68.5 | 62 | | 69 | 65 |

| | | | | | |
|---|---|---|---|---|---|
| coat weight (gsm/side) | 5 | 12 | 12 | 13 | 12 |

Indeed using the proposed coating formulation in the mill trial it was possible to essentially reduce (reduction to half of the usual amount) or even fully eliminate the use of offset powder/overprint varnish without any unacceptable ink scuff problems in commercial printing tests. The rest of the regular properties of the paper again is not measurably altered by the addition of the proposed surface-treated Talcum by 5 parts of the pigment part, making it an ideal supplement in case of ink scuff problems, as its addition does not necessitate further amendments of the rest of the coating formulation due to secondary effects introduced by the speciality Talcum.

Further Experiments:

The further trials used a further slightly different pigment part composition as follows from Table 4:

TABLE 4
Formulations and results of three further
trial papers with standard middle layer.

| Expt. | A | B | C |
|---|---|---|---|
| PIGMENT | | | |
| Aluminum tri-hydroxide | 35 | 45 | 42 |
| untreated Talcum | 25 | | |
| Polybloc | 20 | 30 | 32 |
| PCC | 20 | 20 | 22 |
| Silcron | | 5 | 4 |
| Properties | | | |
| Gloss TAPPI 75° | 23 | 12 | 15 |
| Brightness | 96 | 96 | 96 |
| Ink rub lab | 1.4 | 1.8 | 2.0 |

Aluminum tri-hydroxide: Hydral Coat 5 (A) or 7 (B,C) as available from Almatis (DE). Hydral Coat 5 is a fully dispersed 0.5 micron particle product available as a slurry and as a dry product. Hydral Coat 7 is a 0.7 micron product available as a slurry and as a dry product. They both are a white aluminum trihydroxide Al(OH)₃ (or ATH). Specifically they are specially precipitated high-purity white aluminum trihydroxide powders with a Z percent brightness value of 99+.
Untreated Talcum Flextalc 610 as available from Speciality Minerals Inc (US) was used. It is an untreated Talcum pigment with a medium particle size of approximately 1 μm.
Polybloc Surface-treated (silanized) Talcum pigment with a median particles size of 2.3 μm as available from Speciality Minerals Inc (US) with about 10% of the particles being above 6 μm and 10% being below 1 μm. The maximum particle size is about 15 μm. The TAPPI brightness is approx. 89%.
PPC Precipitated calcium carbonate pigment, specifically the product Albaglos S as available from Speciality Minerals Inc (US) was used. The median particle size of this pigment is 0.6 μm, and it has a surface area (BET) of 9 m²/g.
Silcron The product Silcron G650 from International Speciality Products (US) was used. This is an amorphous silica gel with a median particle size of 4.3 μm, a pore volume of 1.2 ml/g and a surface area (BET) of 290 m²/g.

The results in all cases were good with burnish and back trap mottle improved in B and C. One can see from the values given in Table 3, the ink rub behaviour is excellent of the coatings A-C.

A good balance to obtain low ink scuff, high brightness, low paper gloss, good ink film continuity, good burnish resistance and good ink set times for a high quality matte paper can generally obtained by using amorphous silica (3 to 10 parts), silanized Talcum (15 to 40 parts), PCC (10 to 40 parts) and ATH (10 to 50 parts). For lowest paper gloss, lowest microgloss and best ink gloss mottle, the paper should not be calendered.

The soft/fine pigment technology can, as outlined above, also be applied to medium and high gloss grades to substantially improve ink rub. One of the important aspects is to combine the silanized Talcum with increasingly finer soft pigments while avoiding medium to coarse ground carbonates (median particle diameter in the range of above or equal to 1-1.5 μm). Examples of this are:
1. Medium gloss grades could use silanized Talcum (5 to 20 parts), clay (10 to 30 parts), 0.5 to 0.8 micron ATH (20 to 40 parts) and PCC (10 to 40 parts).
2. High gloss grades could use silanized Talcum (5 to 10 parts), clay (10 to 50 parts), 0.2 to 0.5 micron ATH (0 to 40 parts); PCC (0 to 50 parts) and very fine ground carbonate (0 to 40 parts, median particle diameter in the range of below or equal to 0.5-0.8 μm).

### LIST OF REFERENCE NUMERALS

1 substrate;
2 second layer;
3 top layer;
4 coated printing sheet.

1. Coated paper for offset printing comprising at least on one side a top coating layer, said top coating layer comprising
a pigment part, the 100 parts in dry weight thereof comprising in the range of 2-40 parts in dry weight of a fine particulate, organically surface-treated and/or impregnated Phyllosilicate pigment,
a binder part of 2-20 parts in dry weight of binder and additives in the range of 0-8 parts in dry weight.

2. Coated paper according to claim 1, wherein the Phyllosilicate pigment is surface-treated and/or impregnated with an organic component, selected from the group consisting of silane coupling agents, polysiloxanes, polyols, fatty acids, fatty acid amines, fatty acid amides, polyether polyols, glycols, fatty acid esters, alkyl sulfonates, aryl sulfonates, in situ calcium stearate in wax and mixtures thereof.

3. Coated paper according to claim 1, wherein the Phyllosilicate pigment is surface-treated and/or impregnated with an organosilane and/or organosiloxane component.

4. Coated paper according to claim 1, wherein the Phyllosilicate pigment is a high purity Talcum pigment with a true Talcum content above 90 wt %.

5. Coated paper according to claim 1, wherein the Phyllosilicate pigment has a hardness below 2 on the Mohs scale.

6. Coated paper according to claim 1, wherein the Phyllosilicate pigment has a median particle size in the range of 1-8 μm.

7. Coated paper according to claim 1, wherein the Phyllosilicate pigment is essentially coated, impregnated and/or reacted with an organosilane, wherein the organosilane is selected from the group consisting of: aminoalkyl-organosilane, vinyl-organosilane, secondaryaminoalkyl-organosilane, sulfanealkyl-organosilane, mercaptoalkyl-organosilane, methacrylatealkyl-organosilane, polyetheralkyl-organosilane, epoxyalkyl-organosilane.

8. Coated paper according to claim 1, wherein the organically surface-treated and/or impregnated Phyllosilicate pigment is present in the pigment part in 3-30 parts in dry weight.

9. Coated paper according to claim 1, wherein for a matte paper with a gloss of less than 40% TAPPI 75°, the organically surface-treated and/or impregnated Phyllosilicate pigment is present in the pigment part in an amount of 3-30 parts.

10. Coated paper according to claim 9, wherein the 100 parts in dry weight of the pigment part consist of:
2-40 parts in dry weight of a fine particulate, organically surface-treated and/or impregnated Phyllosilicate pigment,
1-20 parts in dry weight of a fine particulate amorphous silica and/or precipitated silica,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate.

11. Coated paper according to claim 9, wherein the final paper intended for use as a printing substrate is either calendered or uncalendered.

12. Coated paper according to claim 9, wherein the coating formulation is essentially free of coarse pigments with a median particle size of larger than or equal to 1.5 μm.

13. Coated paper according to claim 1, wherein for a medium gloss paper with a gloss of in the range of 30-75% TAPPI 75°, the organically surface-treated and/or impregnated Phyllosilicate pigment is present in the pigment part in an amount of 2-30 parts.

14. Coated paper according to claim 13, wherein the 100 parts in dry weight of the pigment part consist of:
2-30 parts in dry weight of a fine particulate, organically surface-treated and/or impregnated Phyllosilicate pigment,
0-20 parts in dry weight of a fine particulate amorphous silica and/or precipitated silica,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate.

15. Coated paper according to claim 1, wherein for a high gloss paper with a gloss of above or equal to 60% TAPPI 75° the organically surface-treated and/or impregnated Phyllosilicate pigment is present in the pigment part in an amount of 2-20 parts.

16. Coated paper according to claim 15, wherein the 100 parts in dry weight of the pigment part consist of:
2-20 parts in dry weight of a fine particulate, organically surface-treated and/or impregnated Phyllosilicate pigment,
0-20 parts in dry weight of a fine particulate amorphous silica and/or precipitated silica,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate.

17. Coated paper according to claim 1, wherein the 100 parts in dry weight of the pigment part consist of the fine particulate, organically surface-treated and/or impregnated Phyllosilicate pigment in the given amount and the remainder, supplementing to 100 parts in dry weight, of a fine particulate pigment selected from the group of: titanium oxide, calcium carbonate, kaoline, plastic pigment, clay, aluminium trihydroxide, gypsum, barium sulfate, silica.

18. Coated paper according to claim 17, wherein the 100 parts in dry weight of the pigment part consist of:
2-30 parts in dry weight of a fine particulate, organically surface-treated and/or impregnated Phyllosilicate pigment,
1-20 parts in dry weight of a fine particulate silica and/or precipitated silica,
and 50-97 parts in dry weight of a fine particulate pigment selected from the group of: calcium carbonate, titanium oxide, kaoline, clay, plastic pigment, aluminium trihydroxide gypsum, barium sulfate.

19. Coated paper according to claim 1, wherein the fine particulate silica, in the form of an amorphous silica gel, has an internal pore volume above 0.2 ml/g, or wherein the fine particulate silica has a surface area above 100 300 m²/g or wherein the fine particulate silica has a median particle size of in the range of 0.1-7 μm.

20. Coated paper according to claim 1, wherein the Phyllosilicate pigment is a Talcum pigment and is present in the pigment part in the range of 3-30 parts in dry weight.

21. Coated paper according to claim 1, wherein the paper can be printed in an offset printing process without the use of offset powder and/or without irradiative drying after printing and/or without use of overprint varnish.

22. Method for making a coated paper for reducing and/or eliminating ink scuff in offset printing processes, wherein a fine particulate surface-treated/impregnated Phyllosilicate pigment is used in the paper coating formulation.

23. Coated paper according to claim 1, wherein the Phyllosilicate pigment is a high purity Talcum pigment with a true Talcum content above 98 wt %.

24. Coated paper according to claim 1, wherein the Phyllosilicate pigment has a median particle size in the range of 2-4 μm, and wherein the Phyllosilicate pigment has a particle size distribution such that approximately at least 10% of the particles are above 5 μm, and approximately at least 10% are below 1 μm.

25. Coated paper according to claim 1, wherein the organically surface-treated and/or impregnated Phyllosilicate pigment is present in the pigment part in 4-10 parts in dry weight.

26. Coated paper according to claim 9, wherein the 100 parts in dry weight of the pigment part consist of:
5-25 parts in dry weight of a fine particulate silanized Talcum,
3-12 parts in dry weight of a fine particulate amorphous silica gel, with a median particle size in the range of 2-6 μm,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate, wherein this remainder comprises 10-40 parts in dry weight of precipitated calcium carbonate or 5-15 parts in dry weight of a plastic pigment, or 10-50 parts in dry weight of aluminium tri-hydroxide, wherein the median particle size of the aluminium tri-hydroxide is less than 0.8 μm.

27. Coated paper according to claim 13, wherein the 100 parts in dry weight of the pigment part consist of:
3-20 parts in dry weight of a fine particulate, silanized Talcum,
3-12 parts in dry weight of a fine particulate silica gel, with a median particle size in the range of 2-6 μm,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate, wherein this remainder comprises 10-40 parts in dry weight of precipitated calcium carbonate or 5-15 parts in dry weight of a plastic pigment, or 10-30 parts of clay or 20-40 parts in dry weight of aluminium tri-hydroxide, wherein the median particle size of the aluminium tri-hydroxide in the range of 0.5-0.8 μm.

28. Coated paper according to claim 15, wherein the 100 parts in dry weight of the pigment part consist of:
3-10 parts in dry weight of a fine particulate, silanized Talcum,
0-20 parts in dry weight of a fine particulate amorphous silica and/or precipitated silica,
and the remainder supplementing to 100 parts in dry weight of a fine particulate pigment selected from the group of: calcium carbonate, kaoline, titanium oxide, clay, plastic pigment, aluminium trihydroxide, gypsum, barium sulfate, wherein this remainder comprises 5-50, in dry weight of precipitated calcium carbonate, or 0-40 parts of a fine ground calcium carbonate or 5-40 parts in dry weight of aluminium tri-hydroxide, wherein the median particle size of the aluminium tri-hydroxide is in the range of 0.2-0.5 μm.

29. Coated paper according to claim 17, wherein the 100 parts in dry weight of the pigment part consist of:
3-15 parts in dry weight of a fine particulate, silanized Talcum pigment,
8-12 parts in dry weight of a fine particulate amorphous silica gel,
and 50-97 parts in dry weight of a fine particulate pigment selected from the group of: calcium carbonate, titanium oxide, kaoline, clay, plastic pigment, aluminium trihydroxide gypsum, barium sulfate.
